(19) United States
(12) Patent Application Publication
(10) Pub. No.: US 2010/0109315 A1
(43) Pub. Date: May 6, 2010

(54) BOOKMARK

(76) Inventor: Shoichi Aoki, Tokyo (JP)

Correspondence Address: NUTTER MCCLENNEN & FISH LLP, SEAPORT WEST, 155 SEAPORT BOULEVARD, BOSTON, MA, 02210-2604, US

(21) Appl. No.: 12/593,714

(22) PCT Filed: Apr. 1, 2008
(86) PCT No.: PCT/JP2008/056464

§ 371 Date: Sep. 29, 2009

(30) Foreign Application Priority Data
Apr. 4, 2007 (JP) 2007-098699

(51) Int. Cl. B42D 9/00

(52) U.S. Cl. 281/42

(57) ABSTRACT

The present invention relates to bookmarks which, when put between pages of a book, not only indicate the page last read, but also may clearly indicate the line last read, and even a character position if needed. The specific configuration of such a bookmark comprises a bookmark body, an indicator section on the bookmark body, and a control section on the bookmark body for contacting with a book to cause the movement of the bookmark body such that the indicator section may indicate a position of a line on a page. With such a configuration, the object of the present invention is to provide bookmarks having simple configurations, which, by an extremely simple operation by a reader, not only indicate the page last read, but also may clearly indicate the line last read, and even a character position if needed.

### BACKGROUND

The present invention relates to a bookmark which, when put between pages of a book, not only indicates the page last read, but also may clearly indicate the line last read, and even a character position if needed.

Numerous bookmarks are conventionally put between pages of a book to indicate the page last read, including, for example, a paper-clip-shaped “automatic bookmark” disclosed in Patent Document 1, and a clip-shaped “automatic bookmark” consisting of a plurality of parts disclosed in Patent Document 2. However, they merely indicate the page last read, not the line and the character position. Consequently, bookmarks for indicating the line last read have been developed, such as a “bookmark for reading” disclosed in Patent Document 3 wherein a guide groove(s) 2 or a guide band 3 is formed in a bookmark sheet 1 to indicate the line using a slider 3 movable along the guide groove(s) 2 or guide band 3 as an indicator; and a “bookmark for reading” disclosed in Patent Document 4 wherein an indicator is provided on a bookmark sheet 1 to indicate the position last read.

Patent Document 1: Japanese Patent Application Publication 2000-238464

Patent Document 2: Japanese Patent Application Publication 2003-266971

Patent Document 3: Japanese Utility Model Application Publication 55-169454

Patent Document 4: Japanese Utility Model Application Publication 58-72073

### SUMMARY OF THE INVENTION

However, any of bookmarks for indicating the line last read requires numerous parts, making its structure complicated.

Further, in use, such a bookmark forces a reader to carry out a predetermined troublesome operation.

The present invention will solve the above problems. The object of the invention is to provide a bookmark having simple configurations, which, by an extremely simple operation by a reader, not only indicates the page last read, but also may clearly indicate the line last read, and even a character position if needed.

In order to solve the above problems, a bookmark according to the present invention comprises a bookmark body, an indicator section on the bookmark body, and a control section on the bookmark body for moving the bookmark body to allow the indicator section to indicate a position of a line on a page.

A bookmark according to claim 2 of the present invention comprises a bookmark body, an indicator section on the bookmark body, and a control section on the bookmark body for contacting with a book to cause the movement of the bookmark body such that the indicator section may indicate a position of a line on a page.

The control section of the bookmark according to claim 3 of the present invention comes into contact with a binding margin base of the book to cause the entire bookmark to rotate about the contact point such that the indicator section may indicate the position of the line on the page.

The control section of the bookmark according to claim 4 of the present invention comes into contact with a book written horizontally or vertically to cause the movement of the bookmark body such that the indicator section may indicate a position of a line or character on a page of the book written horizontally or vertically.

A bookmark according to claim 5 of the present invention comprises a bookmark body, an indicator section on the bookmark body, and a control section on the bookmark body for contacting with a contact member disposed on a book to cause the movement of the bookmark body such that the indicator section may indicate a position of a line on a page.

The bookmark body according to claim 6 of the present invention has a length approximate to a transverse length of the page.

The total length of the bookmark body according to claim 7 of the present invention is less than or equal to the length between a binding margin base and the farthest line from binding margin base or between the binding margin base and the farthest group of characters from the binding margin base.

The bookmark body according to claim 8 of the present invention is formed of a deformable material.

The bookmarks according to the present invention, when put between pages of a book, not only indicate the page last read, but also may clearly indicate the line last read, and even a character position if desired.

### BRIEF DESCRIPTION OF THE DRAWINGS

FIG. 1 is a perspective view of a bookmark according to a first embodiment of the present invention.

FIG. 2 is an illustration diagram of the bookmark according to the first embodiment of the present invention used in a book written vertically.

FIG. 3 is an illustration diagram of the bookmark according to the first embodiment of the present invention used in a book written horizontally.

FIG. 4 is a perspective view of a bookmark according to a second embodiment of the present invention.

FIG. 5 is a perspective view of the bookmark according to the second embodiment of the present invention.

FIG. 6 is an illustration of the use of a bookmark according to a third embodiment of the present invention.

FIG. 7 is an illustration of the use of a bookmark according to a fourth embodiment of the present invention.

FIG. 8 is an illustration of the use of a bookmark according to a fifth embodiment of the present invention.

FIG. 9 is a perspective view of alternative bookmarks according to a sixth embodiment.

FIG. 10 is an illustration of the use of the bookmark according to the sixth embodiment.

FIG. 11 is a perspective view of alternative bookmarks according to a seventh embodiment of the present invention.

FIG. 12 is a perspective view of alternative bookmarks according to the seventh embodiment of the present invention.

FIG. 13 is a perspective view of the alternative bookmark according to the seventh embodiment of the present invention.

FIG. 14 is a perspective view of an alternative bookmark according to an eighth embodiment of the present invention.

### DETAILED DESCRIPTION

### First Embodiment

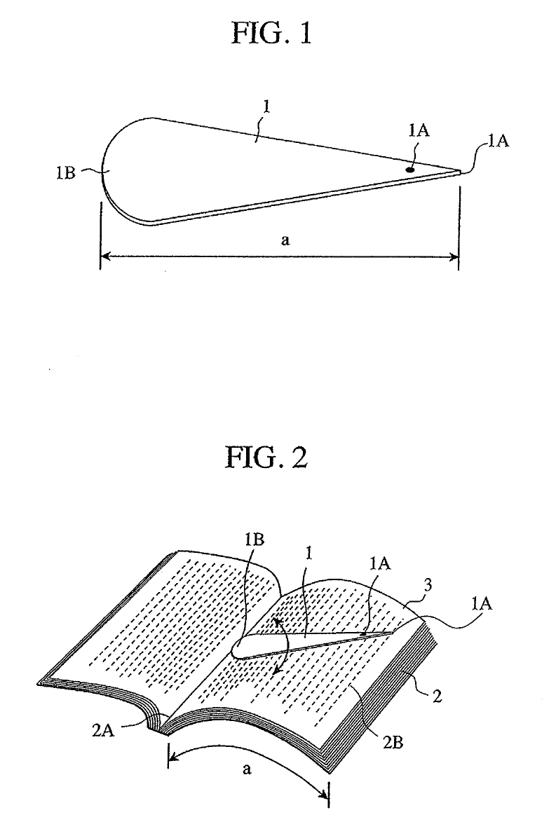

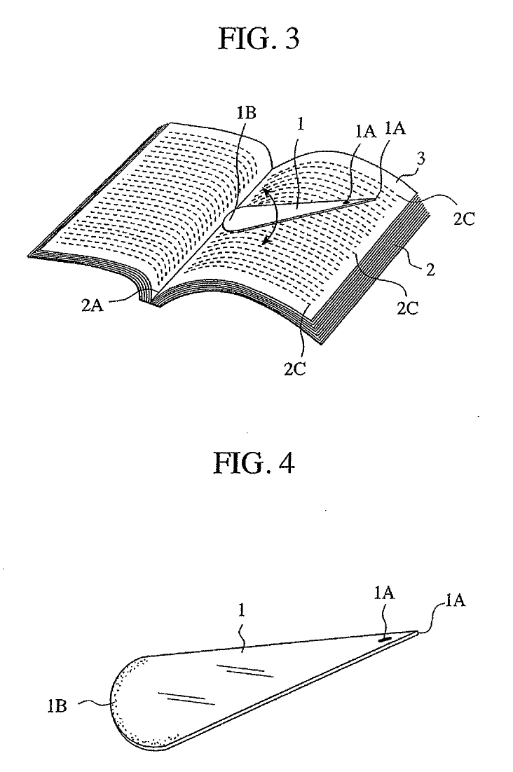

FIG. 1 is a perspective view of a bookmark according to a first embodiment of the present invention. FIG. 2 is an illustration diagram of the bookmark according to the first embodiment of the present invention used in a book written vertically. FIG. 3 is an illustration diagram of the bookmark according to the first embodiment of the present invention used in a book written horizontally.

The length of a bookmark body 1 of the bookmark according to the first embodiment, as shown in FIG. 1, is approximately equal to a transverse length a of a page 3 of a book 2. A mark 1A is formed near one end of the bookmark body 1 to indicate a position of a line or character in the book 2. On the other hand, a control section 1B is formed at the other end of the bookmark body 1. The control section 1B comes into contact with a binding margin base 2A of the book 2 to cause the bookmark body 1 to rotate about the contact point for rotationally moving the mark (indicator section) 1A to the position of the line or character to be indicated. In other words, the control section 1B is the section for contacting with the book 2, and thereby having a function to cause the movement of the bookmark body 1 for allowing the mark 1A to indicate the position of the line or character on the page 3.

When the bookmark body 1 is rotated about the contact point between the control section 1B and the binding margin base 2A, this binding margin base 2A functions as a wall against the control section 1B so that the bookmark body 1 may be surely and smoothly rotated about the contact point.

(Longitudinal Length of the Bookmark Body 1)

The longitudinal length of the bookmark body 1 in FIG. 1 is approximately equal to the transverse length a of the page 3. However, the longitudinal length of the bookmark body 1 may not be limited to such a length, and may include any length that enables the clear indication of the line last read, and even a character position if needed.

For example, when the bookmark is used to indicate a line, and even a character position if needed, in a book written vertically, the bookmark body 1 requires at least the length from the binding margin base 2A to the farthest line 2B from the binding margin base 2A as shown in FIG. 1.

When the bookmark is used to indicate a line, and even a character position if needed, in a book written horizontally, the length from the binding margin base 2A to the farthest characters from the binding margin base 2A (the farthest group of characters) 2C is required.

However, if only the line should be indicated, the bookmark body 1 may be much shorter. That is, even if the total length of the bookmark body is less than or equal to the length between the binding margin base 2A and the farthest line 2B from the binding margin base 2A or between said binding margin base 2A and the farthest characters from the binding margin base 2A (the farthest group of characters) 2C, the line and character position may be clearly indicated.

Accordingly, the longitudinal length of the bookmark body 1 may be properly chosen and modified depending on the purpose or status of use, such as a book type (either written vertically or horizontally), and the target to be indicated (either only the line, or the line and character position).

(Material for Forming the Bookmark Body 1)

Any material that may function as a bookmark may form the bookmark body 1, such as plastic, paper, metal, fabric, and ceramic. A preferred material includes, for example, a transparent material enabling characters to be read through the bookmark body 1; a flexible material that, when the book 2 bends or is deformed, is deformable to conform to the shape of the book 2; a colored material for more clearly indicating the position of the line or character in the book 2; or a material having different colors on its both sides (e.g., blue on its front side and yellow on its back side) for distinction between two facing pages.

In addition, the bookmark body 1 may have any thickness that can indicate the desired line or character position.

(Mark 1A on the Bookmark Body 1)

While the bookmark body 1 in FIG. 1 employs a circular dot as the shape of the mark 1A, any other mark indicating the desired line or character position may be employed, such as a line, rough section, arrow, and characteristic-shaped section on the bookmark itself (e.g., a tail of an animal, and a projection.). For example, in FIGS. 1 and 2, a tip of the bookmark body 1, as well as the black dot shown, function as the mark 1A. Further, an appropriate section of the bookmark body 1 may properly function as the control section 1B or as the mark 1A depending on the status of use.

In addition, a mark (indicator section) separate from the bookmark body 1 may be fixedly or detachably provided on the bookmark body 1. Also in such a case, the appropriate section may properly function as the control section 1B or as the mark 1A.

(Shape of the Control Section 1B of the Bookmark Body 1)

The bookmark body 1 shown in FIG. 1 employs a semicircular shape for the control section 1B. However, any shape other than a circular shape may be employed, as long as the control section 1B comes into contact with the binding margin base 2A of the book 2 to cause the bookmark body 1 to rotate about the contact point between a side face of the control section 1B and the binding margin base 2A such that the mark 1A is rotationally moved to the position of the line or character to be indicated.

Also, a control section 1B separate from the bookmark body 1 may be fixedly or detachably provided on the bookmark body 1 for allowing the mark (indicator section) 1A to indicate the position of the line or character on the page.

The control section 1B causes the bookmark body 1 to rotate about the contact point between the control section 1B and the binding margin base 2A to rotationally move the mark 1A to the position of the line or character to be indicated. However, the control section 1B may come into contact with any portion other than the binding margin base 2A as long as the bookmark body 1 may be rotated so as to rotationally move the mark 1A to the position of the line or character to be indicated.

The use of the bookmark according to the present invention will now be described.

When the bookmark is used to indicate a line, and even a character position if desired, in a book written vertically, the control section 1B of the bookmark body 1 is brought into contact with the binding margin base 2A as shown FIG. 1 to cause the bookmark body 1 to rotate about the contact point for rotationally moving the mark 1A to the position of the line or character to be indicated.

In the book written vertically, since the binding margin base 2A and each line are parallel, the distance measured horizontally from the binding margin base 2A to any one line will be constant. Thus, the position where the control section 1B is in contact with the binding margin base 2A may be anywhere on the binding margin base 2A, and the operation for indicating the position of the line or character is extremely simple.

In this case, since the control section 1B is semicircular, the bookmark body 1 may be extremely smoothly rotated.

When this bookmark is used in a book written horizontally, the control section 1B of the bookmark body 1 is similarly brought into contact with the binding margin base 2A as shown in FIG. 2 to cause the bookmark body 1 to rotate about the contact point for rotationally moving the mark 1A to the position of the line or character to be indicated.

In the book written horizontally, the binding margin base 2A and each line are not parallel. Thus, in indicating the line or character position by the mark 1A, the bookmark body 1 is moved along the binding margin base 2A; or alternatively, the bookmark body 1 is moved along the binding margin base 2A and rotated about the contact point between the control section 1B and the binding margin base 2A, thereby rotationally moving the mark 1A to the line or character position.

### Second Embodiment

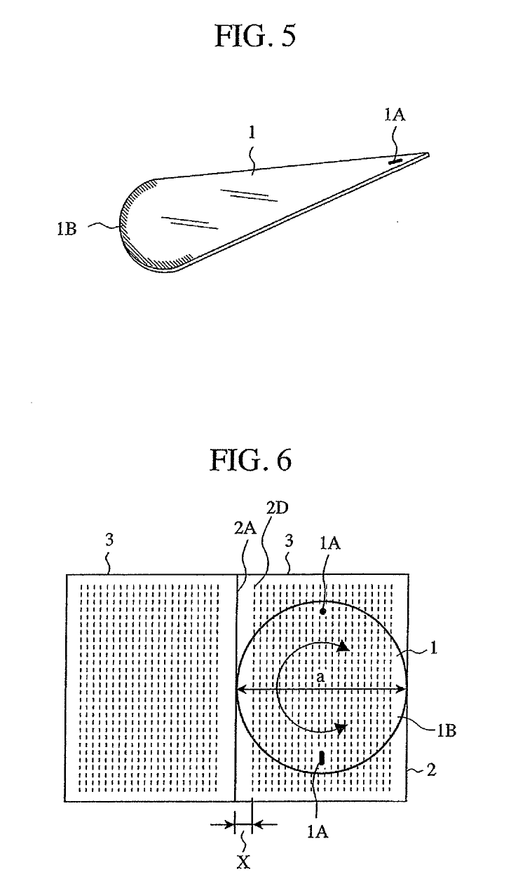

FIGS. 4 and 5 are perspective views of the bookmark according to the second embodiment of the present invention.

While the bookmark body 1 of the bookmark described in the first embodiment will not typically cause any slippage when put between pages 3 of the book 2, the bookmark body 1 according to the second embodiment is provided with an anti-slippage section 1C on a portion thereof. The section having a large friction coefficient may be provided as the anti-slippage section 1C on a portion of the bookmark body 1, or the entire bookmark body 1 may be formed of a material having a large friction coefficient.

### Third Embodiment

FIG. 6 is an illustration of the use of the bookmark according to a third embodiment of the present invention.

The bookmark body 1 according to the third embodiment has a circular shape having a diameter approximately equal to the transverse length a of the page 3. Therefore, a circumference of the bookmark body 1 functions as the control section 1B, and as shown in FIG. 6, the control section 1B of the bookmark body 1 is brought into contact with the binding margin base 2A to cause the rotation of the bookmark body 1 for rotationally moving the mark 1A to the position of the line or character to be indicated.

Thus, the position where the control section 1B of the bookmark body 1 is in contact with the binding margin base 2A may be anywhere on the binding margin base 2A, and the operation for indicating the line or character position is extremely simple. In addition, since the control section 1B is circular, the bookmark body 1 may be extremely smoothly rotated.

Further, the bookmark body 1 according to the third embodiment may be used in any books written vertically or horizontally.

### Fourth Embodiment

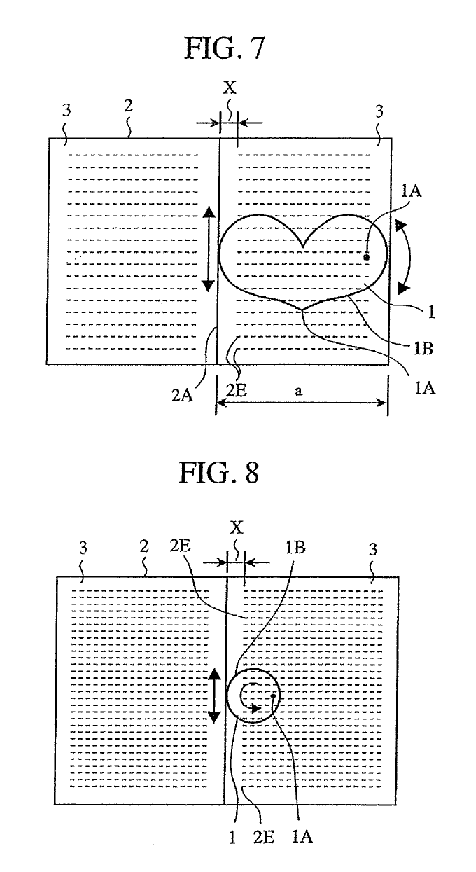

FIG. 7 is an illustration of the use of the bookmark according to a fourth embodiment of the present invention.

The bookmark body 1 according to the fourth embodiment is formed into a heart-shaped configuration having a longitudinal length approximately equal to the transverse length a of the page 3. Thus, the heart-shaped circumference of the bookmark body 1 functions as the control section 1B.

By moving the bookmark body 1 rotationally or up and down along the binding margin base 2A as shown by arrows in FIG. 7 with the control section 1B of the bookmark body 1 in contact with the binding margin base 2A, the mark 1A may be rotationally moved to the position of the line or character to be indicated.

Therefore, the operation for indicating the line or character position is extremely simple. Since the control section 1B is circular, the bookmark body 1 may be extremely smoothly rotated.

Further, the bookmark according to the fourth embodiment may be used in any books written vertically or horizontally.

### Fifth Embodiment

FIG. 8 is an illustration of the use of the bookmark according to a fifth embodiment of the present invention.

The bookmark body 1 according to the fifth embodiment is formed into a circular shape. Thus, its circumference functions as the control section 1B. The bookmark body 1 has a reduced diameter so as to indicate a line of a book written horizontally.

By moving the bookmark body 1 up and down or rotationally along the binding margin base 2A as shown by arrows in FIG. 8 with the control section 1B of the bookmark body 1 in contact with the binding margin base 2A, the mark 1A may be rotationally moved to the position of the line to be indicated. The operation for indicating the line is extremely simple. In addition, since the control section 1B is circular, the bookmark body 1 may be extremely smoothly rotated.

### Sixth Embodiment

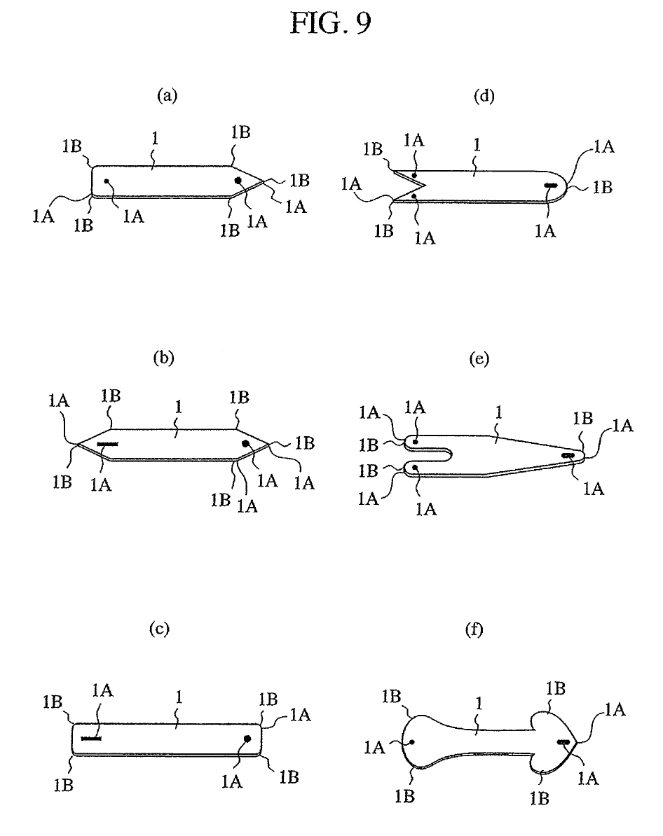

FIG. 9 is a perspective view of alternative bookmarks according to a sixth embodiment of the present invention.

The result of an experiment revealed that not only a curved shape of the control section 1B such as a circular or oval shape, but also other shapes capable of contacting with the binding margin base 2A, such as a bended, acute-angled, or square shape, allow the bookmark body 1 to be smoothly rotated.

FIG. 9 shows some of alternative bookmarks. Their appropriate sections function as the control section 1B depending upon the status of use.

The longitudinal length of the bookmark body 1 according to the sixth embodiment, as described above, may be properly chosen and modified depending on the purpose or status of use, such as a book type (either written vertically or horizontally), and the target to be indicated (either only the line, or the line and character position).

The transverse length of the bookmark body 1 according to the sixth embodiment may also be properly chosen and modified depending on the purpose or status of use, such as a book type (either written vertically or horizontally), and the target to be indicated (either only the line, or the line and character position).

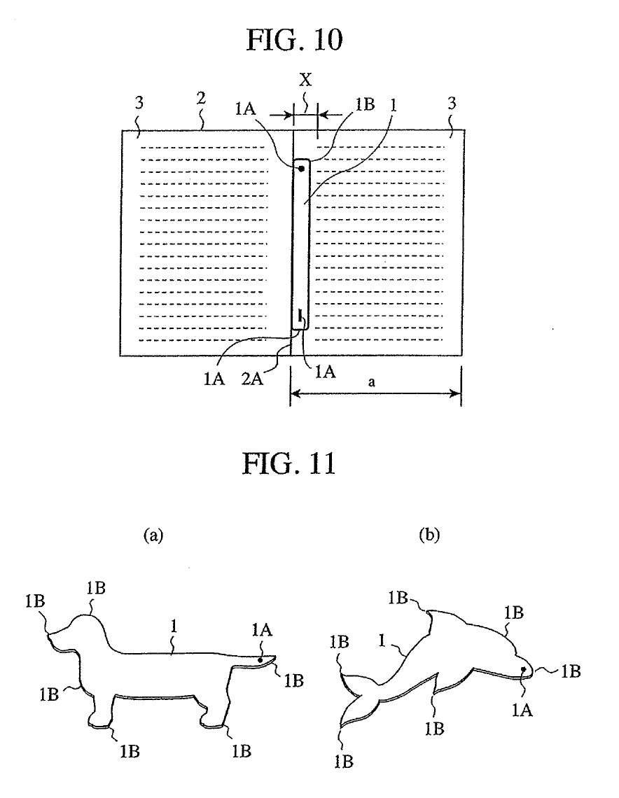

In one preferred embodiment, for example, assuming that the length between the binding margin base 2A and the nearest line 2D to the binding margin base 2A as shown in FIG. 6 or between the binding margin base 2A and the nearest characters to the binding margin base 2A (the nearest group of characters) 2E as shown in FIGS. 7 and 8 is X, and that the transverse length of the bookmark body 1 is less than or equal to the length X, the placement of the bookmark body 1 in contact with and parallel to the binding margin base 2A as shown in FIG. 10 when reading prevents the bookmark body 1 from crossing characters, such that reading will not to be disturbed.

### Seventh Embodiment

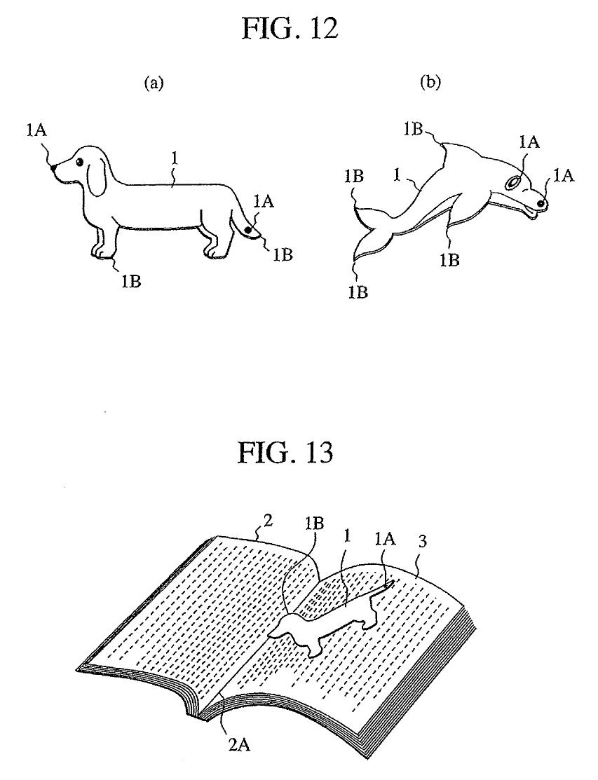

FIGS. 11, 12 and 13 are perspective views of alternative bookmarks according to a seventh embodiment of the present invention.

Each of the bookmark bodies 1 according to the seventh embodiment symbolizes an animal shape, and causes its appropriate section to function as the control section 1B or causes its characteristic-shaped section (e.g., a tail, nose, leg, and fin of the animal) and the like to function as the mark 1A depending on the status of use.

The longitudinal and transverse lengths of the bookmark bodies 1 according to the seventh embodiment may be properly chosen and modified depending on the purpose or status of use, such as a book type (either written vertically or horizontally), and the target to be indicated (either the line only, or the line and character position).

### Eighth Embodiment

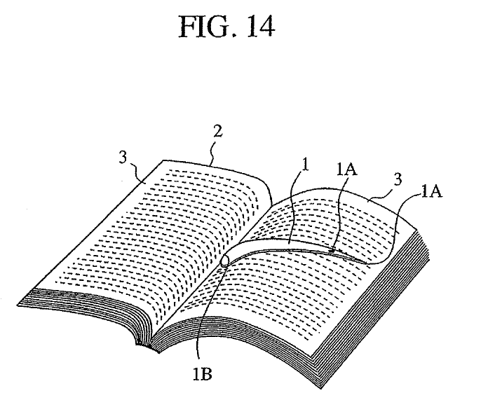

FIG. 14 is a perspective view of an alternative bookmark according to an eighth embodiment of the present invention.

The bookmark body 1 according to the seventh embodiment is originally formed into a deformed shape curved along the shape of the page 3. For example, even if the book 2 such as a thick book is curved due to its large number of pages, the bookmark body 1 conforms to the surface of the page 3 without lifting, so as to surely and clearly indicate a line, and even a character position if desired.

The bookmark body 1 may also be formed of a deformable material to be flexibly deformable.

Such a deformed bookmark body 1 also conforms to the surface of the page 3 without lifting, so as to surely and clearly indicate the line, and even the character position if needed.

### Ninth Embodiment

In the aforementioned embodiments, the control section 1B comes into contact with the book 2 to cause the bookmark body 1 to rotate about the contact point such that the mark 1A is rotationally moved to the position of the line or character to be indicated.

On the other hand, in the bookmark according to the ninth embodiment of the present invention, a control-section-contacting member (contact member) (e.g., a member formed of plastic, paper, metal, fabric, ceramic, and the like having a plate-like, linear, curved, rod-like, or the other shape (not shown)), which comes into contact with the control section 1B along or near the binding margin base 2A to cause the bookmark body 1 to rotate about the contact point, is inserted into or attached to the book 2. With this arrangement, the control section 1B, as the first embodiment, causes the bookmark body 1 to rotate about the contact point between the control section 1B and the control-section-contacting member (contact member) (not shown) to rotationally move the mark 1A to the position of the line or character to be indicated.

In the bookmark according to the ninth embodiment, the control-section-contacting member separate from the book 2 is attached to the book 2 to provide the section contacting with the control section 1B. However, the control-section-contacting member may be any other means capable of rotating the bookmark body 1 for rotationally moving the mark 1A to the position of the line or character to be indicated, such as a portion of a case cover (not shown) for the book 2, and other dedicated parts.

Further, the bookmark and the control-section-contacting member; the bookmark and the case cover (not shown) for the book 2; or the bookmark and the other dedicated parts may be formed integrally.

### INDUSTRIAL APPLICABILITY

The present invention relates to a bookmark which, when put between pages of a book, not only indicates the page last read, but also may clearly indicate the line last read, and even a character position if needed.

1. A bookmark comprising:
a bookmark body,
an indicator section on the bookmark body, and
a control section on the bookmark body for moving the bookmark body to allow the indicator section to indicate a position of a line on a page.

2. A bookmark comprising:
a bookmark body,
an indicator section on the bookmark body, and
a control section on the bookmark body for contacting with a book to cause the movement of the bookmark body such that the indicator section may indicate a position of a line on a page.

3. The bookmark according to claim 2, characterized in that the control section comes into contact with a binding margin base of the book to cause the entire bookmark to rotate about the contact point such that the indicator section may indicate the position of the line on the page.

4. The bookmark according to claim 2, characterized in that the control section comes into contact with a book written horizontally or vertically to cause the movement of the bookmark body such that the indicator section may indicate a position of a line or character on a page of the book written horizontally or vertically.

5. A bookmark comprising:
a bookmark body,
an indicator section on the bookmark body, and
a control section on the bookmark body for contacting with a contact member disposed on a book to cause the movement of the bookmark body such that the indicator section may indicate a position of a line on a page.

6. The bookmark according to claim 5, characterized in that the bookmark body has a length approximate to a transverse length of the page.

7. The bookmark according to claim 5, characterized in that the total length of the bookmark body is less than or equal to the length between a binding margin base and the farthest line from the binding margin base or between the binding margin base and the farthest group of characters from the binding margin base.

8. The bookmark according to claim 5, characterized in that the bookmark body is formed of a deformable material.

9. The bookmark according to claim 1, characterized in that the bookmark body has a length approximate to a transverse length of the page.

10. The bookmark according to claim 1, characterized in that the total length of the bookmark body is less than or equal to the length between a binding margin base and the farthest line from the binding margin base or between the binding margin base and the farthest group of characters from the binding margin base.

11. The bookmark according to claim 1, characterized in that the bookmark body is formed of a deformable material.

12. The bookmark according to claim 2, characterized in that the bookmark body has a length approximate to a transverse length of the page.

13. The bookmark according to claim 2, characterized in that the total length of the bookmark body is less than or equal to the length between a binding margin base and the farthest line from the binding margin base or between the binding margin base and the farthest group of characters from the binding margin base.

14. The bookmark according to claim 2, characterized in that the bookmark body is formed of a deformable material.
